(19) United States
(12) Patent Application Publication
(10) Pub. No.: US 2018/0089583 A1
(43) Pub. Date: Mar. 29, 2018

(54) TRAINING METHODS FOR SMART OBJECT ATTRIBUTES

(71) Applicant: Intel Corporation, Santa Clara, CA (US)

(72) Inventors: Ravishankar Iyer, Portland, OR (US); Glen J. Anderson, Beaverton, OR (US); Omesh Tickoo, Portland, OR (US); David I. Poisner, Carmichael, CA (US); Therese E. Dugan, Sunnyvale, CA (US); Mark R. Francis, Portland, OR (US); Yevgeniy Y. Yarmosh, Portland, OR (US)

(21) Appl. No.: 15/278,503

(22) Filed: Sep. 28, 2016

(51) Int. Cl. G06N 99/00; G06F 3/14; G06N 5/04

(52) U.S. Cl. CPC G06N 99/005; G06F 3/048; G06N 5/04; G06F 3/14

(57) ABSTRACT

Systems, apparatuses and methods may provide for training smart objects. More particularly, Systems, apparatuses and methods may provide training smart objects and users to understand actions and commands, using sensors and actuators. Systems, apparatuses and methods may also provide smart objects and users a way to communicate training to other smart objects and users.

### TECHNICAL FIELD

Embodiments generally relate to training smart objects. More particularly, embodiments relate to training smart objects and users to understand actions and commands, using sensors and actuators.

### BACKGROUND

Current training systems have been applied to, for example, robotic applications, where a user shows a robot an object and says, “This is a cat.” The user may show the device many sample cats, and the system may even conduct a database search (e.g., Google images) to find more examples of cats. The system then develops a model for cats and may then recognize cats. Some systems also assign attributes to the identified object, such as weight, size ranges, species type (e.g., animal, plant), fictional and non-fictional, age (e.g., a young or old example of the object), and so forth.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a training system configuration according to an embodiment;

FIG. 2 is a block diagram of an example of a training system according to an embodiment;

FIG. 3A is a block diagram of an example of a smart object according to an embodiment;

FIG. 3B is a block diagram of an example of a central device according to an embodiment;

FIG. 4 is a flowchart of an example of a method of training a smart device according to an embodiment;

FIG. 5 is a flowchart of an example of a method of operation of a smart device according to an embodiment;

FIG. 6 is a block diagram of an example of a processor according to an embodiment; and

FIG. 7 is a block diagram of an example of a computing system according to an embodiment.

### DESCRIPTION OF EMBODIMENTS

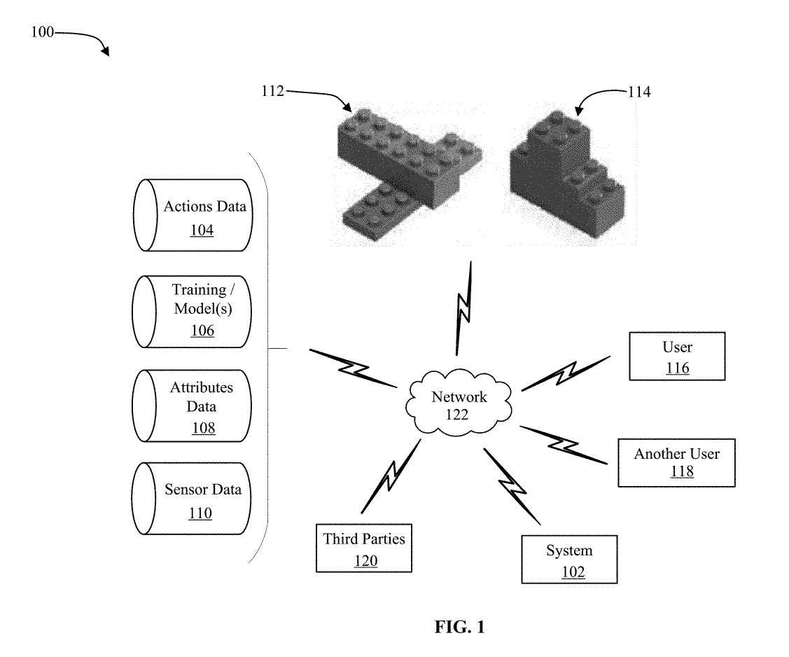

Turning now to FIG. 1, an illustration of an example of a training system configuration 100 is shown. The illustrated training system configuration 100 includes a training system 102, which may include, receive and/or retrieve action data 104, training models 106, attributes data 108 and sensor data 110. The training system 102 may communicate with one or more objects (e.g., smart objects) 112, 114 and/or one or more users 116, 118 that the training system 102 trains and monitors. In general, two or more users or objects may interact with each other. In one embodiment, two or more users 116, 118, objects 112, 114 or third parties 120 may interact with each other. Third parties 120 may provide one or more training models or services to users and/or objects based on actions data and sensor data. The training system 102 may communicate with various components of the training system configuration 100 via a network 122 (e.g., the Internet).

The training system 102 and/or smart objects 112, 114 may include multiple sensors (e.g., cameras and audio recognition systems), and share attributes, recognized actions and outputs with other smart objects 112, 114 so that the users 116, 118 (e.g., multiple children) may play together in the same geographical location and/or remotely. For example, a child may choose to duplicate an object's attributes by saying “This toy [toy #2] is now just like that toy [toy #1]”, where toy #1 is smart object 112 and previously known to be owned by child #1, and toy #2 is smart object 114 and owned by child #2.

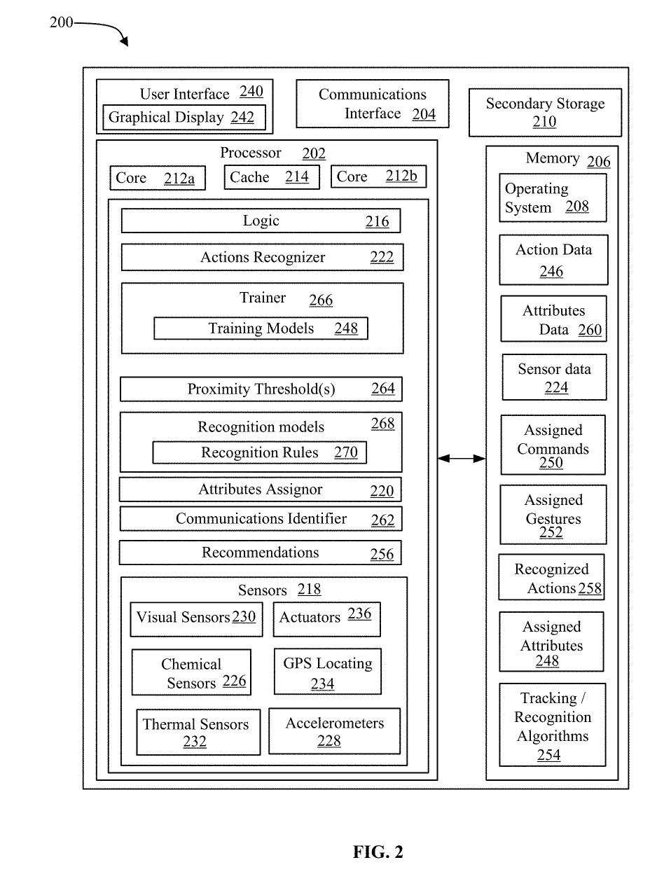

FIG. 2 is a block diagram of an example of a training system 200 according to an embodiment. The training system 200, which may be readily substituted for the system 102 (FIG. 1), already discussed, may include a processor 202, a communications interface 204 and memory 206 coupled to the processor 202. The illustrated processor 202 runs an operating system (OS) 208. The memory 206 may be external to the processor 202 (e.g., external memory), and/or may be coupled to the processor 202 by, for example, a memory bus. In addition, the memory 206 may be implemented as main memory. The memory 206 may include, for example, volatile memory, non-volatile memory, and so on, or combinations thereof. For example, the memory 206 may include dynamic random access memory (DRAM) configured as one or more memory modules such as, for example, dual inline memory modules (DIMMs), small outline DIMMs (SODIMMs), etc., read-only memory (ROM) (e.g., programmable read-only memory (PROM), erasable PROM (EPROM), electrically EPROM (EEPROM), etc.), phase change memory (PCM), and so on, or combinations thereof. The memory 206 may include an array of memory cells arranged in rows and columns, partitioned into independently addressable storage locations. The processor 202 and/or operating system 208 may use a secondary memory storage 210 with the memory 206 to improve performance, capacity and flexibility of the training system 200.

The training system 200 may include cores 212a, 212b that may execute one or more instructions such as a read instruction, a write instruction, an erase instruction, a move instruction, an arithmetic instruction, a control instruction, and so on, or combinations thereof. The cores 212a, 212b may, for example, execute one or more instructions to move data (e.g., program data, operation code, operand, etc.) between a cache 214 or a register (not shown) and the memory 206 and/or the secondary memory storage 210, to read the data from the memory 206, to write the data to the memory 206, to perform an arithmetic operation using the data (e.g., add, subtract, bitwise operation, compare, etc.), to perform a control operation associated with the data (e.g., branch, etc.), and so on, or combinations thereof. The instructions may include any code representation such as, for example, binary code, octal code, and/or hexadecimal code (e.g., machine language), symbolic code (e.g., assembly language), decimal code, alphanumeric code, higher-level programming language code, and so on, or combinations thereof. Thus, for example, hexadecimal code may be used to represent an operation code (e.g., opcode) of an x86 instruction set including a byte value “00” for an add operation, a byte value “8B” for a move operation, a byte value “FF” for an increment/decrement operation, and so on.

The training system 200 may include logic 216 to coordinate processing among various components and/or subsystems of the training system 200. The training system 200 may include one or more sensors 218, an attributes assignor 220 and an actions recognizer 222.

The sensors 218 may record actions of one or more users or objects as sensor data 224. The sensors 218 may include one or more of chemical sensors 226, accelerometers 228, visual sensors 230 (e.g., cameras, optical sensors), infrared sensors, pressure sensors, thermal sensors 232, global positioning system (GPS) locating sensors 234 or inertial movement sensors, wherein the one or more sensors are to record sensory data including one or more of visual, audio, motion, tactile, smell, chemical or thermal data. The training system 200 and/or objects may include one or more actuators 236 or user interface 240 including one or more visual displays 242 (e.g., graphical display) to interact with one or more users or objects.

The actions recognizer 222 may recognize one or more users or objects, based on analysis of the actions 246 recorded by the sensors as sensor data 224 and the assigned attributes 248. The actions recognizer 222 may recognize one or more users or objects, actions requested by the users and/or objects, and actions 258 performed by the users and/or objects. The actions recognizer 222 may recognize users and/or objects based on the attributes the users and/or objects exhibits, and tracking and recognition algorithms 254. The actions recognizer 222 may recognize one or more interactions between two or more of the users and/or objects, by analyzing attribute assignments 246, assigned commands 250 and assigned gestures 252, and comparing previously and currently recorded visual, audio, motion, tactile, smell, chemical or thermal data recorded by the sensors. The actions recognizer 222 may use the recognition algorithms 254 and one or more recognition models 268 with recognition rules 270 to recognize one or more users or objects.

The attributes assignor 220 may assign attributes 246 to one or more users or objects. The attributes assignor 220 may receive attribute assignments 260 from one or more users or objects, and generate attribute assignment recommendations 256 for selection. The assigned attributes 248 may include, for example, one or more modalities including motion, visual elements and patterns, or environments determined by one or more of visual, audio, tactile, smell or thermal signatures, chemicals, pressure, radio identifier (ID), or radio presence including (radio frequency identifier) RFID, near field communications (NFC), Bluetooth, WiFi, frequency and radio pattern, signal strength, or capacitance.

The assigned attributes 248 may include an identity, for example, a communications identifier 262, including properties to identify one or more environments, users or objects by one or more of name, color, size, sound characteristics, radio identifier, motion, tactile, smell, chemical or thermal signatures, the characteristic of a particular gesture of a user. Attributes of a user may be assigned to objects and vice versa, for example, the name assigned the object by a user, one or more sound and/or actuator outputs may occur for when a given range of motion amplitude is recorded by one or more sensors.

The assigned attributes 248 may be based on proximity of a radio transmitter, such as a toy with an RFID tag coming in proximity, e.g., approaches within a configurable proximity threshold 264, to another toy (e.g., object) that has an RFID reader. Additionally, a child (e.g., a user) may assign a command 250 and/or gesture 252 to one object and that command may cause an action to be performed and/or recognized by the object. Also, a child (e.g., a user) may assign a command 250 and action to one object and when the sensors recognize the action 258 and command being recorded (e.g., performed, observed) with one object and that object may command another object to also perform an action 246 (e.g., actuate an actuator 236, lighting, audio, motion or some other modality).

The training system 200 may include a trainer 266 to train the sensors 218 and the actions recognizer 222, using one or more training models 268, in one or more training modes to sense and recognize environments, one or more users or objects, including an audio training mode, a visual and infrared training mode, a chemical training mode, a thermal training mode, a wireless communications training mode, tactile and smell training modes or a motion and orientation training mode. One or more users or objects may communicate training from the trainer to one or more other users or objects.

The training system 200 and/or objects may operate in multiple training modes, including explicit training and passive training. During explicit training, the user provides some indicator that training is about to be performed, which may be via a verbal or gesture prefix, or through a verbal sentence construction. For example, the user may communicate “This is a lion!” recognized by the training system 200 and/or object as an explicit emphatic statement, or when a user shakes an object left-to-right and the user says “This is SUPERMAN”.

During passive training, the training system 200 may observe the ‘Play’ and attempt to build rules based on observing the play. For example, if the user performs an action (e.g., three times in a row, consecutively or a pattern) and makes some audible sound, the training system 200 may deem the action and/or audible sound to be a desired recognized action and output, even if the user (e.g., child) may not provide an explicit command.

During hybrid training, the training system 200 may responsively prompt the user to explicitly train the training system 200. Then the training system 200 and/or smart objects may observe, via sensors, the ‘Play’ and attempt to build additional rules to improve recognition accuracy. In hybrid training mode, the training system 200 may utilize rules created by one or more users (e.g., crowd sourcing).

The training system 200 may utilize rules created (e.g., generated) by one or more users (e.g., saved and accessed remotely in the Cloud) during, for example, explicit training to improve accuracy of recognition or/and shorten the training time. The training system 200 may utilize rules created (e.g., generated) by one or more users to predict/guess the intent of a current user during passive training. Once training is completed, the training system 200 may automatically revert to ‘Play’ mode where the training system 200 and/or one or more objects attempt to recognize actions and interactions of users and objects.

The term “modality” may include one or more characteristics of one or more environments, users, objects or modalities on which the training system 200 may train, including sound, visual elements, activity from motion data, chemical detection, radio ID, radio pattern or signal strength.

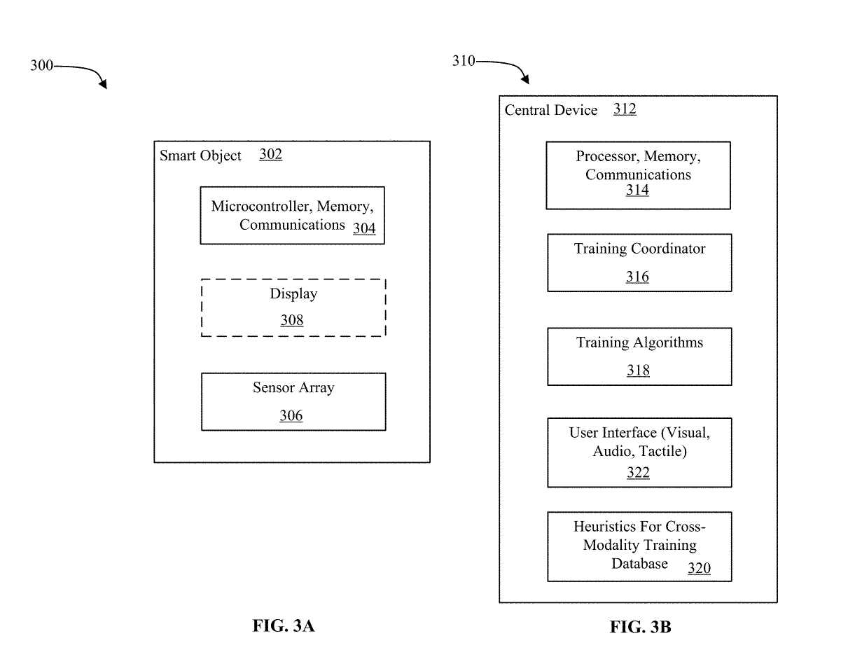

FIG. 3A is a block diagram 300 of an example of a smart object 302 according to an embodiment. The smart object 302 may include a microcontroller, memory and communications components 304. The smart object 302 may also include a sensor array 306 and display 308 and/or user interface.

FIG. 3B is a block diagram 310 of an example of a central device 312 according to an embodiment. The central device 312 may include a processor, memory and communications components 314. The central device 312 may also include a training coordinator 316, training algorithm engine and/or logic 318. The central device 312 may include a heuristics engine 320 that uses a cross-modality training database, and use the training algorithm engine and/or logic 318 and/or heuristics engine 320 to train one or more recognition models. The central device 312 may also include a user interface 322 for one or more users to interact with the smart object 302 and/or the central device 312.

The training coordinator 316 may receive input from the various sensing and radio modalities, and communicate data into machine recognition training modules. The training system may use the training modules to track completion of model training for one or more modalities.

Table 1 shows some examples of a variety of possible modality pairings.

TABLE 1

| Modality set | User training indication to system |
|---|---|
| Radio ID + visual | Name the radio, display the object at |
| pattern | various angles in front of the camera, |
| | name desired sound effect |
| Radio ID + visual | Name and perform the gesture, object |
| pattern + motion | within radio distance, display the object at |
| | various angles in front of the camera |
| Visual pattern + | Name the object, display the object at |
| motion | various angles in front of the camera, |
| | name and perform the gesture |
| Chemical | Name object, hold object within chemical |
| detection and | sensor distance, name a sound effect |
| visual pattern | |
| Touch gesture + | Provide touch gesture, name desired |
| visual pattern | output |
| Gesture/Action + | Name object A, assign action to Object A, |
| multiple visual | perform gesture/action with Object A this |
| patterns | causes desired output on Object B |

The smart objects may include computing devices with wireless communication, sensor array, processing and memory. The smart objects may communicate among various components using one or more protocols (e.g., wireless). The training system may track smart objects which may include, electronic components, including sensors and actuators. The training system may include a subsystem to render 2d or 3d models based on sensory data identifying objects of interest, and convert multiple 2d images of objects into 3D models.

The training system may include a subsystem (e.g., implemented employing augmented reality software development kit/SDK) that performs marker and “markerless” tracking to track angle changes of objects. The training system may include object recognition and tracking components, and tracking algorithms for speech recognition, gesture recognition based on motion sensing, proximity detection based on motion sensing, reed switch, and NFC tracking.

The training system may include further include machine recognition training modules for one or more modalities. The training system may employ wireless radio signature, pattern, and strength algorithms. The training system may communicate in a crowd sourcing mode with one or more cloud service (e.g., third party) to collect and manage the recognition rules, which may be shared across multiple users.

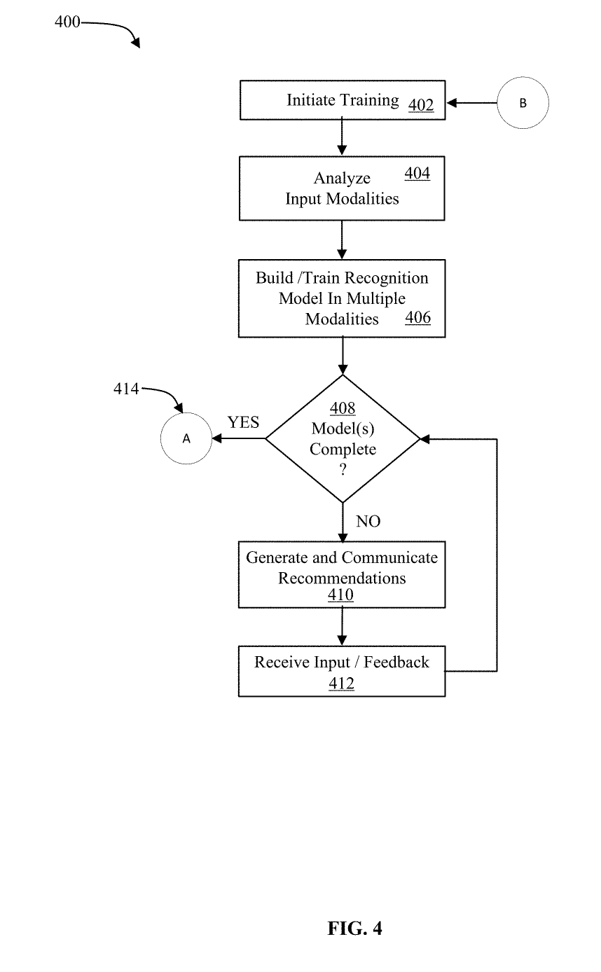

FIG. 4 shows an example of a method 400 of training a smart device according to an embodiment. The method 400 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 400 may be written in any combination of one or more programming languages, including an object oriented programming language such as JAVA, SMALLTALK, C++ or the like and conventional procedural programming languages, such as the “C” programming language or similar programming languages.

Illustrated processing block 402 provides for initiating training of the sensors and the actions recognizer in one or more training modes to sense and recognize one or more environments, users or objects. The training modes (e.g., modalities of training) may include one or more of an audio training mode, a visual and infrared training mode, a chemical training mode, a thermal training mode, a wireless communications training mode, tactile and smell training modes, or a motion and orientation training mode.

Illustrated processing block 404 provides for analyzing sensor data input modalities. The sensor data may include recorded actions of one or more users or objects in response to communications from the training system directed to one or more modalities, including motion data, audio data, visual patterns, radio presence or some other modality. The sensor data may be analyzed for matches and/or correlations, according to one or more configurable tolerance thresholds, from among one or more modalities.

Illustrated processing block 406 provides for building and/or training one or more recognition models in one or more modalities. Recognition models may be used to recognize sensor data, users, objects, environments and modalities. Recognition models may be built by creating one or more recognition rules based on the quantity and quality of the one or more matches and/or correlations between attributes identified from the sensor data across one or more modalities. Recognition models may be trained by including the assigned attributes as recognition factors used to recognize sensor data, users, objects, environments and modalities. New recognition models may be created by combining one or more components of one or more completed or partially completed recognition models. New recognition models may be provided by one or more third parties.

Illustrated processing block 408 provides for determining whether the one or more recognition models are complete. A recognition model may be determined to be complete based on the quantity and quality of one or more matches and/or correlations between the sensor data and one or more assigned attributes of one or more users, objects, environments and modalities. If a recognition model is determined to be complete at block 408, the method 400 may transition to node 414 and the recognition model may be used to responsively interact with one or more users or objects.

Illustrated processing block 410 provides for generating and communicating one or more recommendations to one or more users or objects. If a recognition model is determined to be incomplete, then one or more recommendations or request for confirmation of completion of the recognition model may be generated and communicated to one or more users or objects. The recommendations may include recommended attribute assignments to assign to one or more of sensor data, users, objects, environments and modalities. The attribute assignments may identify and/or correspond to one or more users, objects or modalities. Attributes assigned to users, objects, environments and modalities may be used to customize recognition models used to recognize one or more users, objects, environments or modalities from the sensor data.

Illustrated processing block 412 provides for receiving input and/or feedback from one or more users or objects in response to one or more recommendations or request for confirmation of completion of the recognition model. The response to one or more of the recommendations may include attribute assignments for one or more of the users, objects, environments or modalities.

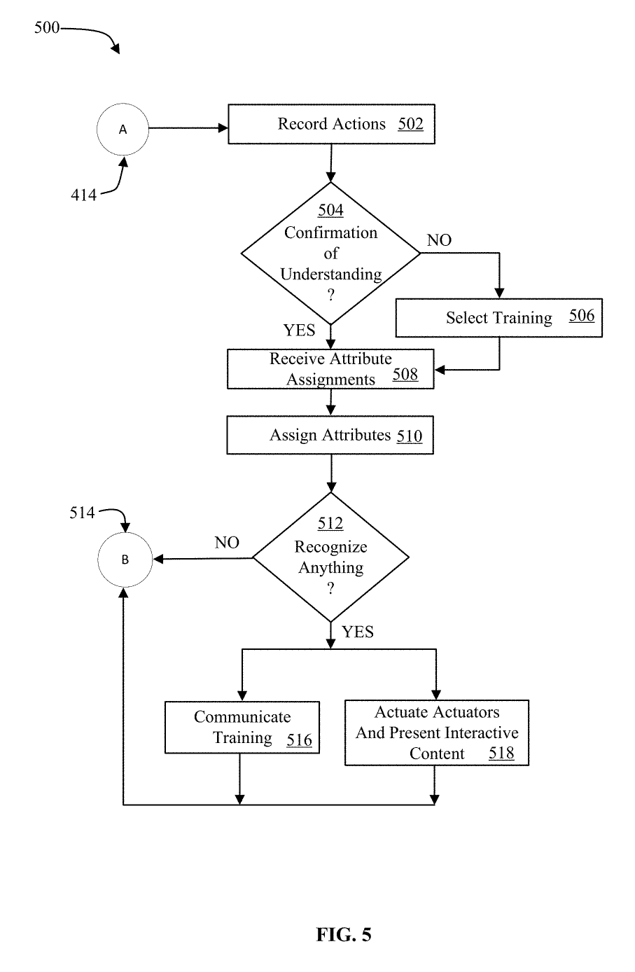

Turning now to FIG. 5, an example is illustrated of a method 500 of operation of a smart device according to an embodiment. The method 500 may be implemented as a module or related component in a set of logic instructions stored in a non-transitory machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 502 provides for recording actions of one or more users and objects, using one or more sensors. The sensors may include one or more of chemical sensors, accelerometers, visual sensors, infrared sensors, pressure sensors, thermal sensors, or inertial movement sensors, or other sensors also configured to record one or more attributes (e.g., aspects) of environment, biological or mechanical systems. The sensors may record sensory data, such as one or more of visual, audio, motion, tactile, smell, chemical, thermal or environmental data. The environmental data may include, for example, one or more of temperature, elevation, pressure or atmosphere.

Illustrated processing block 504 provides for requesting confirmation of understanding of training. Users and objects may be directed to confirm understanding of training, and based on one or more responses from the users and objects, confirm understanding of training may be determined.

Illustrated processing block 506 provides for selecting one or more training modes, based on one or more responses from the users and objects requested to confirm understanding of training. Users and objects may be presented with one or more training modes in a configurable order. One or more training modes may be presented on a configurable frequency (e.g., schedule) based on one or more configurable thresholds of understanding (e.g., 70%, 80%). The training modes may include one or more of an audio training mode, a visual and infrared training mode, a chemical training mode, a thermal training mode, a wireless communications training mode, tactile and smell training modes, or a motion and orientation training mode.

Illustrated processing block 508 provides for receiving, by the attributes assignor, attribute assignments from a user, and generating, using the attributes assignor, attribute assignment recommendations for the user to select, wherein the assigned attributes include one or more modalities including motion, visual elements and patterns or environments determined by one or more of visual, audio, tactile, smell or thermal signatures, chemicals, pressure, radio identifier (ID) or radio presence including RFID, NFC, Bluetooth, WiFi, frequency and radio pattern, signal strength, or capacitance, the characteristic of a particular gesture of a user. Attributes of a user may be assigned to objects and vice versa, for example, the name assigned the object by a user, one or more sound and/or actuator outputs may occur for when a given range of motion amplitude is recorded by one or more sensors.

Illustrated processing block 510 provides for assigning, by an attributes assignor, one or more attributes to the user and the object. The assigned attributes include an identity including properties to identify the object by one or more of name, color, size, sound characteristics, radio identifier, motion, tactile, smell, chemical or thermal signatures.

Illustrated processing block 512 provides for recognizing, by an actions recognizer, the user and the object based on the actions recorded by the sensors. The actions recognizer is to further recognize the user, another user, the object and the other object, wherein the actions recognizer is to recognize the actions of actions requested by the user, actions performed by the user, the another user, the object and the other object, and interactions between two or more of the user, the another user, the object or the other object, by comparing previously recorded or current visual, audio, motion, tactile, smell, chemical or thermal data recorded by the sensors.

Illustrated node 514 provides for communicating training to one or more of users or objects. The users and objects may communicate training to each other to allow users and objects in one or more environments to acquire common knowledge about and recognize one or more environments, users, objects or modalities.

Illustrated processing block 516 provides for actuating one or more actuators and presenting, using a visual display, interactive content to interact with one or more of user or object. One or more objects may include one or more actuators or visual displays, used to perform actions and communicate with one or more users or objects. For example, sound or lighting of one or more objects may be actuated to emulate one or more attributes assigned to the objects.

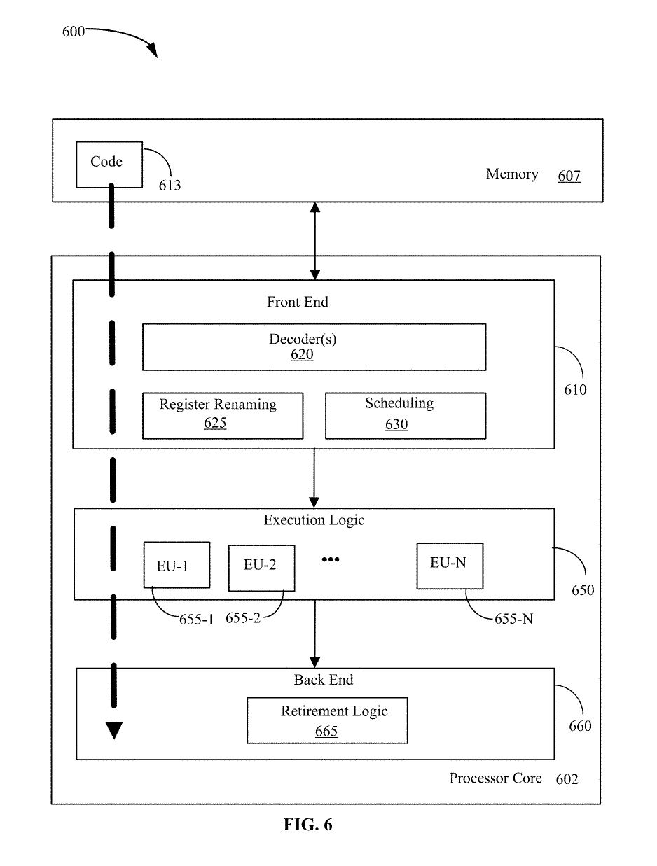

FIG. 6 is a block diagram 600 of an example of a processor core 602 according to one embodiment. The processor core 602 may be the core for any type of processor, such as a micro-processor, an embedded processor, a digital signal processor (DSP), a network processor, or other device to execute code. Although only one processor core 602 is illustrated in FIG. 6, a processing element may alternatively include more than one of the processor core 602 illustrated in FIG. 6. The processor core 602 may be a single-threaded core or, for at least one embodiment, the processor core 602 may be multithreaded in that it may include more than one hardware thread context (or “logical processor”) per core.

FIG. 6 also illustrates a memory 607 coupled to the processor core 602. The memory 607 may be any of a wide variety of memories (including various layers of memory hierarchy) as are known or otherwise available to those of skill in the art. The memory 607 may include one or more code 613 instruction(s) to be executed by the processor core 600, wherein the code 613 may implement the method 400 (FIG. 4) and/or the method 500 (FIG. 5), already discussed. The processor core 602 follows a program sequence of instructions indicated by the code 613. Each instruction may enter a front end portion 610 and be processed by one or more decoders 620. The decoder 620 may generate as its output a micro operation such as a fixed width micro operation in a predefined format, or may generate other instructions, microinstructions, or control signals which reflect the original code instruction. The illustrated front end portion 610 also includes register renaming logic 625 and scheduling logic 630, which generally allocate resources and queue the operation corresponding to the convert instruction for execution.

The processor core 602 is shown including execution logic 650 having a set of execution units 655-1 through 655-N. Some embodiments may include a number of execution units dedicated to specific functions or sets of functions. Other embodiments may include only one execution unit or one execution unit that can perform a particular function. The illustrated execution logic 650 performs the operations specified by code instructions.

After completion of execution of the operations specified by the code instructions, back end logic 660 retires the instructions of the code 613. In one embodiment, the processor core 600 allows out of order execution but requires in order retirement of instructions. Retirement logic 665 may take a variety of forms as known to those of skill in the art (e.g., re-order buffers or the like). In this manner, the processor core 602 is transformed during execution of the code 613, at least in terms of the output generated by the decoder, the hardware registers and tables utilized by the register renaming logic 625, and any registers (not shown) modified by the execution logic 650.

Although not illustrated in FIG. 6, a processing element may include other elements on chip with the processor core 602. For example, a processing element may include memory control logic along with the processor core 602. The processing element may include I/O control logic and/or may include I/O control logic integrated with memory control logic. The processing element may also include one or more caches.

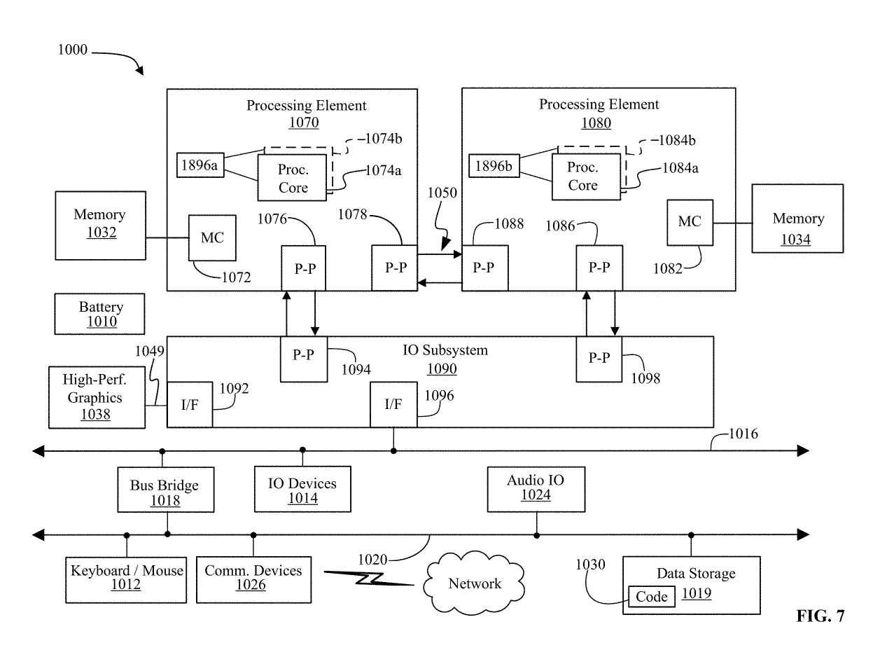

Referring now to FIG. 7, shown is a block diagram of a computing system 1000 embodiment in accordance with an embodiment. Shown in FIG. 7 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 7, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 7, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 7, various I/O devices 1014 (e.g., speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 400 (FIG. 4) and/or the method 500 (FIG. 5), already discussed, and may be similar to the code 613 (FIG. 6), already discussed. Further, an audio I/O 1024 may be coupled to second bus 1020 and a battery 1010 may supply power to the computing system 1000.

Note that other embodiments are contemplated. For example, instead of the point-to-point architecture of FIG. 7, a system may implement a multi-drop bus or another such communication topology. Also, the elements of FIG. 7 may alternatively be partitioned using more or fewer integrated chips than shown in FIG. 7.

The training system provides a very interactive approach to teaching a system to recognize objects in various ways, assign attributes to environments, users, objects and modalities, and recognize actions of users and objects. The training may occur across various modalities. The training may occur in different ways and may involve objects (e.g., toys and/or smart objects) that have embedded sensors.

A user may assign (e.g., associate) various attributes to the user, other users, objects, environments and modalities, converted into tags, which assign the attributes. The attributes may be shared with other users who have instances of same or similar objects. Categories of tags may include identity, actions, interactions and output.

The identity tag may include properties that may identify, for example, the object (e.g., a name which may be arbitrarily assigned), color(s), size, sound characteristics and a radio signature. The actions and interactions tags may identify actions and interactions that may be taken with the object that may be recognized through the camera, audio, assembled parts detection, or motion sensors during play. The interactions include interactions with other users and other objects. The output tag may include outputs (actions and interactions) that may be performed during ‘Play’ when the actions and interactions are recognized.

For example, a smart object may be implemented to recognize objects such as a toy. A child (e.g., user) may present a toy in front of the smart object with a camera (e.g., optical sensor) and address the system verbally, for example, “This is Super Man,” while holding a toy in the frame of the camera. The smart object may ask the child to show different angles of the toy to allow recognition from all sides. The user may then tell the smart object, “Super Man says, ‘Never fear!’” Subsequently, when a toy with a camera (e.g., as part of the smart object) sees a toy or object that is or is similar to a Super Man toy or oriented in frame similar to how an object was previously oriented during a previous recording of the toy or another object, the smart object may play a sound effect (e.g., “Never fear!”).

In another example, a child may build a toy (e.g., toy model) from standard blocks (e.g., LEGO bricks), then train the smart object to recognize the toy as a particular object or character. For example, the child may put a few bricks together in a certain way and call the bricks an airplane or a tank. Further, the child may make a gesture with the object and audibly and/or some other mode of communications indicate, “It is flying now.” Subsequently, when the smart object detects the brick configuration with matching motion data, the system may play a sound effect associated with an airplane flying. The training system may have default profiles for various objects, for example, airplanes and tanks so that when objects assigned the attributes of airplanes and tanks interact with each other, as detected by one or more sensors (e.g., motion, visual optical, infrared), the training system may generate sound effects (e.g., default sound effects).

The training system trains the smart object to recognize actions and interactions. For example, in front of a camera, a child (e.g., user) may bump two toys (e.g., objects) into each other and indicate, communicate and/or say, “This is a crash. Run motor in reverse.” The training system may ask the child to repeat the action multiple times in order to allow the system to build a motion model of the crash using motion sensor data from the two toys. Subsequently, when these two toys (e.g., objects), or perhaps others from a same set of objects crash into or come within some configurable proximity (e.g., distance, time) to each other, the toys (e.g., objects) may reverse motors after bumping. Or, for example, a toy with capacitive sensing, may communicate an audio and other form of communications to communicate “When I do this, a genie answers,” while making a touch gesture on the toy.

The training system may train a smart object to recognize sound by entering the smart object into an audio training mode, the child (e.g., user, one or more objects) may make noises, and train the system and smart object to recognize the noises. The training system may request that the child repeat the action multiple times to build (e.g., create, generate) a recognition model.

The objects may be assigned one or more radio-based identities. The user may also add a radio and/or broadcast brick (e.g., component), a sort of identity token, to a model and give the object an identification. For example, the child (e.g., user) may say, “This is a 777 jet.” Then the training system and/or object assigned one or more corresponding attribute may play the 777 engine noise sound effect whenever that radio is detected. The radio may be RFID, NFC, Bluetooth or some other communications protocol. In one embodiment, the radio-based identify may eliminate or limit the need for the training system and/or smart object to include one or more of a camera, optical sensors or infrared sensors. The radio-based identity may be included in a token of the object, and the token may be configured with a pre-defined value (e.g., a lion), or the token may be trained/assigned an attribute (e.g., identity type) by either child (e.g., user) and/or a parent, teacher, therapist or supervisor of the user.

The training system includes machine learning that directs one or more users or objects in actions to train on one or more modality (e.g., motion data, visual patterns, radio presence). For example, training one or more users or objects visual recognition of one or more environments, users, objects or modalities, while the one or more users or objects create (e.g., generate) motion data to train across one or more modality.

The training system may allow a user to nominally assign a radio ID to an object, which is subsequently recognized by the training system based on a combination of radio and visual recognition or some other modality. The training system may coordinate assembly of blocks or toys with add-on accessories (e.g., attributes). The training system may allow a user to assign motion data to a nominal action, which is subsequently recognized by the training system based on motion data.

Modalities of training may include sound, visual elements (e.g., patterns, colors, fiducial markers), activity from motion data, chemical detection (e.g., “smell this soup” to train on chemical), radio ID (RFID, NFC, Bluetooth, WiFi, etc.), radio pattern, radio signal strength, pressure, capacitance.

Training may be transferred across other objects, or shared with other people, as configured by the user. Transferring training to other users and objects may improve the time and speed up the recognition process, for example, enlisting third parties (e.g. crowd sourcing in a form of Cloud service) to assist one or more users or objects to recognize users or objects.

The training system may train one or more users or objects to recognize one or more commands and actions. For example, a camera of the training system and/or object may record a child (e.g., user) picking up a toy (e.g., object) and assigning the toy an audio and gestural command. For example, a child may pick up a doll (e.g., smart object) and hold the doll in front of the camera (e.g., optical sensor) and the child may tell the doll, “when I hug you, say ‘I love you’”. Then when the child preforms the action by hugging the doll and the doll says “I love you” when hugged.

The training system may train one or more users or objects to train one or more users or objects. For example, a camera of the training system and/or object may record a child (e.g., user) picking up a toy (e.g., object) and assigning the toy an audio and gestural command and then once the child performs the command and assigns the action the toy may command another toy to also perform an action. For example, a child picks up her doll and holds the doll in front of the camera. The child may tell the doll, “when I hug you, say ‘I love you’”. Then the child preforms the action by hugging the doll and the doll says “I love you” when hugged. Next, the child tells the doll “when I hug you say ‘I love you’ and tell the bear to say ‘I love you too’”. So the child hugs the doll and the doll says “I love you” and then the doll tells the bear (e.g., another object) “say I love you too” and then the bear says “I love you too”.

The training system may train one or more users or objects to recognize one or more actions and voice commands. For example, when a child (e.g., user) assigns a command to an object (e.g., toy doll), and then performs an action in proximity (e.g., distance and time) to another object (e.g., a bear), the other object may be assigned to recognize the action and/or command. For example, a child may assign (e.g., associate) a word like “abracadabra” and gestures by flicking a wand. When the child performs the gesture (e.g., action) in front of the camera of the training system and/or object, the training system and/or object associates the gesture and word together. So that when a child (e.g., user) performs that gesture (e.g., flicking wand towards optical sensor of the training system and/or object) and says the associated word (e.g., abracadabra), the training system and/or object may recognize the action of the first object (e.g., the wand) which may cause a reaction by a second object (e.g., the bear). So that when a child says “abracadabra” and flicks the wand towards the camera (e.g., optical sensor) the training system and/or object associates the wand and the word together. Then when the child points the wand at the bear in proximity to other objects and says “you are now under my spell, jump, shake, blink”, every time the child does both the action (e.g., gesture) and says the magic word (e.g., points the wand at object and says abracadabra) at the bear, the bear may jump, shake and/or blink.

The training system and/or object may provide and/or include a large number of sound effects or voice output preconfigured pared with recognized voice inputs. For example, the training system and/or object may include a natural language module that may determine the desired command from an utterance and pair the command with the trained event (e.g., the site, sound, or motion of the toy—object). The training system and/or object may randomize various sound effects or chosen by a user using a user interface that assigns a sound effect to a character and/or an action. The training system and/or object may include a large vocabulary of recognized (e.g., understood) commands and/or a natural speech recognition engine, using existing technologies. The training system and/or object may include various actuators and outputs (e.g., motor direction, motor speed, visual output on a display and/or user interface).

The training system and/or object may recognize actions and interactions via one or more sensors besides a camera (e.g., optical sensor). The training system and/or object may recognize actions and interactions via a user (e.g., a child) saying something (“Here comes the horse”) or based on a sensor built into the object (e.g., toys). For example, attribute determination (visual, audio) may be used to designate an object to exhibit one or more attributes (e.g., a sound associated with a “Genie”). The training system and/or object may use recognized actions to assign a sound (e.g., “Genie Appears”) whenever the user (e.g., a child) touches a capacitive touch sensor on the object (e.g., toy).

The training system provides a way to designate an attribute to an object although the object does not resemble an attribute associated with that object. For example, a child (e.g., user) may have a stuffed cat (e.g., object) that may normally be recognized as a cat, but for the purpose of play the stuffed cat (e.g., object) may be assigned attributes of a lion because the child indicates and/or says “This is a lion”.

The training system allows new attributes assigned to one or more users or objects to be arbitrary. For example, a child may make up a new sound that is played whenever a particular toy is moved in a particular way or the toy is moved toward another toy or particular other toy.

The training system may train one or more objects complex actions and interactions, such as two or more objects touching, coming into proximity (e.g., distance and time) and/or “crashing” based on proximity reducing to zero at a specified rate of speed of the objects, then the objects responsively actuate one or more actuators across one or more modalities (e.g., sound, lighting, vibration, motion, temperature) when a crash is detected by one or more sensors (e.g., proximity sensors, cameras, accelerometers, pressure or capacitive sensors) implemented in the smart objects observing an area or space (e.g., geographical, virtual, augmented).

The training system may also generate complex outputs. For example, when the proximity of two or more objects reduces (e.g., approaches within a configurable threshold) to zero, the amplitude of the audio “crash” sound may be adjusted based on the crash velocity, and the objects may perform actuate other actions, such as a “back up sound” if the velocity is low enough such that the crash is not deemed “too destructive” (e.g., a configurable threshold based on the speed of the objects at the point of the crash). The training system may assign outputs to a library of pre-defined events (e.g., may playing of sound sequences or random sequences, activation of motors and LEDs).

### ADDITIONAL NOTES AND EXAMPLES

Example 1 may include a smart objects training apparatus comprising one or more sensors to record actions of a user and an object, an attributes assignor to assign attributes to the user and the object, and an actions recognizer to recognize the user and the object, based on the actions recorded by the sensors.

Example 2 may include the apparatus of Example 1, wherein the attributes assignor is to receive input (e.g., attribute assignments) from the user and generate attribute assignment recommendations for the user to select based on the input, wherein the assigned attributes include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements.

Example 3 may include the apparatus of any one of Examples 1 to 2, wherein the assigned attributes include an identity including properties to identify the object by one or more of name, color, size, sound characteristics, radio identifier, motion, tactile, smell, chemical or thermal signatures.

Example 4 may include the apparatus of Example 3, wherein the one or more sensors are to further record actions of another user and another object, wherein the sensors include one or more of chemical sensors, accelerometers, visual sensors, infrared sensors, pressure sensors, thermal sensors or inertial movement sensors, and wherein the one or more sensors are to record sensory data including one or more of visual, audio, motion, tactile, smell, chemical or thermal data.

Example 5 may include the apparatus of Example 4, wherein the actions recognizer is to further recognize the other user and the other object, and one or more actions requested by the user, actions performed by the user, the other user, the object and the other object, and interactions between two or more of the user, the other user, the object or the other object, by comparing previously recorded and current visual, audio, motion, tactile, smell, chemical or thermal data recorded by the sensors.

Example 6 may include the apparatus of any one of Examples 1 to 2, further including a trainer to train the sensors and the actions recognizer in one or more training modes to sense and recognize environments, the user, another user, the object and another object, the one or more training modes including an audio training mode, a visual and infrared training mode, a chemical training mode, a thermal training mode, a wireless communications training mode, a tactile training mode, a smell training mode, a motion training mode, or an orientation training mode.

Example 7 may include the apparatus of Example 6, further including one or more actuators and a visual display to interact with one or more of the user or the other object.

Example 8 may include the apparatus of Example 6, wherein one or more of the object or the other object communicates training data from the trainer to one or more of the object, the user or the other object.

Example 9 may include the apparatus of any one of Examples 1 to 2, wherein the attributes assignor is to assign a motion to an action for the object, and wherein the actions recognizer is to recognize the object based on the attributes that the object exhibits.

Example 10 may include a method of training a smart object and user comprising recording, using one or more sensors, actions of a user and an object, assigning, by an attributes assignor, one or more attributes to the user and the object, and recognizing, by an actions recognizer, the user and the object based on the actions recorded by the sensors.

Example 11 may include the method of Example 10, further comprising receiving, by the attributes assignor, input (e.g., attribute assignments) from a user, and generating, using the attributes assignor, attribute assignment recommendations for the user to select based on the input, wherein the assigned attributes include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements.

Example 12 may include the method of any one of Examples 10 to 11, wherein the assigned attributes include an identity including properties to identify the object by one or more of name, color, size, sound characteristics, radio identifier, motion, tactile, smell, chemical or thermal signatures.

Example 13 may include the method of Example 12, wherein the one or more sensors further are to record actions of another user and another object, and wherein the sensors include one or more of chemical sensors, accelerometers, visual sensors, infrared sensors, pressure sensors, thermal sensors, or inertial movement sensors, wherein the one or more sensors are to record sensory data including one or more of visual, audio, motion, tactile, smell, chemical or thermal data.

Example 14 may include the method of Example 13, wherein the actions recognizer is to further recognize the other user and the other object, and one or more of actions requested by the user, actions performed by the user, the other user, the object and the other object, and interactions between two or more of the user, the other user, the object or the other object, by comparing previously recorded or current visual, audio, motion, tactile, smell, chemical or thermal data recorded by the sensors.

Example 15 may include the method of any one of Examples 10 to 11, further including training the sensors and the actions recognizer in one or more training modes to sense and recognize environments, the user, another user, the object and another object, the one or more training modes including an audio training mode, a visual and infrared training mode, a chemical training mode, a thermal training mode, a wireless communications training mode, a tactile training mode, a smell training modes, a motion training mode, or an orientation training mode.

Example 16 may include the method of Example 15, further including actuating one or more actuators and a visual display to interact with one or more of the user or the other object.

Example 17 may include the method of Example 15, wherein one or more of the object and the other object communicates training data to one or more of the object, the user or the other object.

Example 18 may include at least one computer readable storage medium comprising a set of instructions, which when executed by a computing device, cause the computing device to record, using one or more sensors, actions of a user and an object, assign attributes, by an attributes assignor, to the user and the object, and recognize, by an actions recognizer, the user and the object based on the actions recorded by the sensors.

Example 19 may include the at least one computer readable storage medium of Example 18, wherein the instructions, when executed, cause a computing device to receive input (e.g., attribute assignments) from a user, and generate attribute assignment recommendations for the user to select based on the input, wherein the assigned attributes include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements.

Example 20 may include the at least one computer readable storage medium of any one of Examples 18 to 19, wherein the assigned attributes include an identity including properties to identify the object by one or more of name, color, size, sound characteristics, radio identifier, motion, tactile, smell, chemical or thermal signatures.

Example 21 may include the at least one computer readable storage medium of Example 20, wherein the sensors further are to record actions of another user and another object, wherein the sensors include one or more of chemical sensors, accelerometers, visual sensors, infrared sensors, pressure sensors, thermal sensors, or inertial movement sensors, and wherein the one or more sensors are to record sensory data including one or more of visual, audio, motion, tactile, smell, chemical or thermal data.

Example 22 may include the at least one computer readable storage medium of Example 21, wherein the actions recognizer is to further recognize the user, the other user and the other object, and wherein the actions recognizer is to recognize one or more actions requested by the user, actions performed by the user, the other user, the object and the other object, and interactions between two or more of the user, the other user, the object or the other object, by comparing previously recorded or current visual, audio, motion, tactile, smell, chemical or thermal data recorded by the sensors.

Example 23 may include the at least one computer readable storage medium of any one of Examples 18 to 19, wherein the instructions, when executed, cause a computing device to train the sensors and the actions recognizer in one or more training modes to sense and recognize environments, the user, another user, the object and other object, the one or more training modes including an audio training mode, a visual and infrared training mode, a chemical training mode, a thermal training mode, a wireless communications training mode, a tactile training mode, a smell training mode, a motion training mode, or an orientation training mode.

Example 24 may include the at least one computer readable storage medium of Example 23, wherein the instructions, when executed, cause a computing device to actuate one or more actuators and present a visual display to interact with one or more of the user or the other object.

Example 25 may include the at least one computer readable storage medium of Examples 18 to 19, wherein the instructions, when executed, cause a computing device to assign a motion to an action for the object, wherein the actions recognizer is to recognize the object based on the attributes the object exhibits.

Example 26 may include a smart objects training apparatus comprising means for recording actions of a user and an object, means for assigning one or more attributes to the user and the object, and means for recognizing the user and the object based on the actions recorded.

Example 27 may include the apparatus of Example 26, further comprising: means for receiving input (e.g., attribute assignments) from a user, and means for generating attribute assignment recommendations for the user to select based on the input, wherein the assigned attributes are to include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements, wherein the assigned attributes are to further include an identity including properties to identify the object by one or more of name, color, size, sound characteristics, radio identifier, motion, tactile, smell, chemical or thermal signatures.

Example 28 may include the apparatus of any one of Examples 26 to 27, wherein the means for recording actions further is to record actions of another user and other object, wherein the means for recording actions include one or more of chemical sensors, accelerometers, visual sensors, infrared sensors, pressure sensors, thermal sensors, or inertial movement sensors, wherein the one or more sensors are to record sensory data including one or more of visual, audio, motion, tactile, smell, chemical or thermal data, and wherein the means for recognizing is to further recognize the other user and the other object, and one or more actions requested by the user, actions performed by the user, the other user, the object and the other object, and interactions between two or more of the user, the other user, the object or the other object, by comparing previously recorded or current visual, audio, motion, tactile, smell, chemical or thermal data recorded by the sensors.

Example 29 may include the apparatus of any one of Examples 26 to 27, further including means for training the means for recording actions and the means for recognizing in one or more training modes to sense and recognize environments, the user, another user, the object and another object, the one or more training modes including an audio training mode, a visual and infrared training mode, a chemical training mode, a thermal training mode, a wireless communications training mode, a tactile training mode, a smell training mode, a motion training mode, or an orientation training mode.

Example 30 may include the apparatus of Example 29, further including means for actuating one or more actuators and a visual display to interact with one or more of the user or the other object, and wherein one or more of the object and the other object is to communicate training data to one or more of the object, the user or the other object.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
one or more sensors to record actions of a user and an object,
an attributes assignor to assign attributes to the user and the object, and
an actions recognizer to recognize the user and the object, based on the actions recorded by the sensors.

2. The apparatus of claim 1, wherein the attributes assignor is to receive input from the user and generate attribute assignment recommendations for the user to select based on the input, wherein the assigned attributes include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements.

3. The apparatus of claim 1, wherein the assigned attributes include an identity including properties to identify the object by one or more of name, color, size, sound characteristics, radio identifier, motion, tactile, smell, chemical or thermal signatures.

4. The apparatus of claim 3, wherein the one or more sensors are to further record actions of another user and another object, wherein the sensors include one or more of chemical sensors, accelerometers, visual sensors, infrared sensors, pressure sensors, thermal sensors or inertial movement sensors, and wherein the one or more sensors are to record sensory data including one or more of visual, audio, motion, tactile, smell, chemical or thermal data.

5. The apparatus of claim 4, wherein the actions recognizer is to further recognize the other user and the other object, and one or more actions requested by the user, actions performed by the user, the another user, the object and the other object, and interactions between two or more of the user, the another user, the object or the other object, by comparing previously recorded and current visual, audio, motion, tactile, smell, chemical or thermal data recorded by the sensors.

6. The apparatus of claim 1, further including a trainer to train the sensors and the actions recognizer in one or more training modes to sense and recognize environments, the user, another user, the object and another object, the one or more training modes including an audio training mode, a visual and infrared training mode, a chemical training mode, a thermal training mode, a wireless communications training mode, a tactile training mode, a smell training mode, a motion training mode, or an orientation training mode.

7. The apparatus of claim 6, further including one or more actuators and a visual display to interact with one or more of the user or the other object.

8. The apparatus of claim 6, wherein one or more of the object or the other object communicates training data from the trainer to one or more of the object, the user or the other object.

9. The apparatus of claim 1, wherein the attributes assignor is to assign a motion to an action for the object, and wherein the actions recognizer is to recognize the object based on the attributes that the object exhibits.

10. A method comprising:
recording, using one or more sensors, actions of a user and an object,
assigning, by an attributes assignor, one or more attributes to the user and the object, and
recognizing, by an actions recognizer, the user and the object based on the actions recorded by the sensors.

11. The method of claim 10, further comprising:
receiving, by the attributes assignor, input from a user, and
generating, using the attributes assignor, attribute assignment recommendations for the user to select based on the input, wherein the assigned attributes include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements.

12. The method of claim 10, wherein the assigned attributes include an identity including properties to identify the object by one or more of name, color, size, sound characteristics, radio identifier, motion, tactile, smell, chemical or thermal signatures.

13. The method of claim 12, wherein the one or more sensors further are to record actions of another user and another object, and wherein the sensors include one or more of chemical sensors, accelerometers, visual sensors, infrared sensors, pressure sensors, thermal sensors, or inertial movement sensors, wherein the one or more sensors are to record sensory data including one or more of visual, audio, motion, tactile, smell, chemical or thermal data.

14. The method of claim 13, wherein the actions recognizer is to further recognize the other user and the other object, and one or more actions requested by the user, actions performed by the user, the other user, the object and the other object, and interactions between two or more of the user, the other user, the object or the other object, by comparing previously recorded or current visual, audio, motion, tactile, smell, chemical or thermal data recorded by the sensors.

15. The method of claim 10, further including training the sensors and the actions recognizer in one or more training modes to sense and recognize environments, the user, another user, the object and another object, the one or more training modes including an audio training mode, a visual and infrared training mode, a chemical training mode, a thermal training mode, a wireless communications training mode, a tactile training mode, a and smell training modes, or a motion training mode, or an and orientation training mode.

16. The method of claim 15, further including actuating one or more actuators and a visual display to interact with one or more of the user or the other object.

17. The method of claim 15, wherein one or more of the object and the other object communicates training data to one or more of the object, the user or the other object.

18. At least one computer readable storage medium comprising a set of instructions, which when executed by a computing device, cause the computing device to:
record, using one or more sensors, actions of a user and an object,
assign attributes, by an attributes assignor, to the user and the object, and
recognize, by an actions recognizer, the user and the object based on the actions recorded by the sensors.

19. The at least one computer readable storage medium of claim 18, wherein the instructions, when executed, cause a computing device to:
receive input from a user, and
generate attribute assignment recommendations for the user to select based on the input, wherein the assigned attributes include one or more modalities including motion, visual elements, visual patterns, or environments determined by one or more of visual signatures, audio signatures, tactile signatures, smell signatures, thermal signatures, chemical measurements, pressure measurements, radio identifier (ID) measurements, or radio presence measurements.

20. The at least one computer readable storage medium of claim 18, wherein the assigned attributes include an identity including properties to identify the object by one or more of name, color, size, sound characteristics, radio identifier, motion, tactile, smell, chemical or thermal signatures.

21. The at least one computer readable storage medium of claim 20, wherein the sensors further are to record actions of another user and another object, wherein the sensors include one or more of chemical sensors, accelerometers, visual sensors, infrared sensors, pressure sensors, thermal sensors, or inertial movement sensors, and wherein the one or more sensors are to record sensory data including one or more of visual, audio, motion, tactile, smell, chemical or thermal data.

22. The at least one computer readable storage medium of claim 21, wherein the actions recognizer is to further recognize the other user and the other object, and one or more actions requested by the user, actions performed by the user, the other user, the object and the other object, and interactions between two or more of the user, the other user, the object or the other object, by comparing previously recorded or current visual, audio, motion, tactile, smell, chemical or thermal data recorded by the sensors.

23. The at least one computer readable storage medium of claim 18, wherein the instructions, when executed, cause a computing device to: train the sensors and the actions recognizer in one or more training modes to sense and recognize environments, the user, another user, the object and other object, the one or more training modes including an audio training mode, a visual and infrared training mode, a chemical training mode, a thermal training mode, a wireless communications training mode, a tactile training mode, a smell training mode, a motion training mode, or an orientation training mode.

24. The at least one computer readable storage medium of claim 23, wherein the instructions, when executed, cause a computing device to actuate one or more actuators and present a visual display to interact with one or more of the user or the other object.

25. The at least one computer readable storage medium of claim 18, wherein the instructions, when executed, cause a computing device to assign a motion to an action for the object, and wherein the actions recognizer is to recognize the object based on the attributes that the object exhibits.
